(19) United States
(12) Patent Application Publication
(10) Pub. No.: US 2014/0185415 A1
(43) Pub. Date: Jul. 3, 2014

(54) Alarm device for banishment of birds and animals

(71) Applicant: Tianjin Changyue Electronic Technology Co. Ltd., Tianjin (CN)

(72) Inventor: Fengyue Bu, Tianjin (CN)

(73) Assignee: TIANJIN CHANGYUE ELECTRONIC TECHNOLOGY CO. LTD., Tianjin (CN)

(21) Appl. No.: 14/201,698

(22) Filed: Mar. 7, 2014

(30) Foreign Application Priority Data
May 22, 2012 (CN) 201220231104/X
May 29, 2012 (CN) PCT/CN2012/076244

(51) Int. Cl. A01M 29/16

(52) U.S. Cl. CPC A01M 29/16
USPC 367/139

(57) ABSTRACT

This utility model releases an alarm device for banishment of birds and animals, which includes: radio transmission module, voltage stabilizing circuit and inverter circuit. The radio transmission module sends radio signals to radio receiver module which then transmits such radio signals to the PC control circuit; the said PC control circuit sends instruction signals to the audio circuit which then transmits the audio signal to amplification circuit which outputs the amplified audio signals; the said voltage stabilizing circuit provides 5V power supply to the said radio transmission module, radio receiver module, the said PC control circuit and the said audio circuit, while the said inverter circuit provides +/−35V power supply to the said amplification circuit. This device banishes birds and animals by simulating human voices, which can save both save human resources and effectively protect the farm crops, on another hand, it helps to protect the birds and wild animals from kills and harms caused by traditional protective methods; therefore, it helps to maintain the ecological balance.

### CROSS-REFERENCE TO RELATED APPLICATION

The application is a continuation of PCT/CN2012/076244(filed on May 29, 2012), which claims priority of Chinese patent application 201220231104.X (filed on May 22, 2012), the contents of which are incorporated herein by reference.

### FIELD OF THE INVENTION

This utility model involves alarm devices, especially an alarm device for banishment of birds and animals.

### BACKGROUND OF THE INVENTION

Orchard and farms in the countryside are troubled by the damages caused by birds and wild boars during nights, which results in loss of agricultural produce.

During the embodiment of this utility model, it is found that the existing technologies have the following disadvantages and defects:

With the existing technologies, farmers tend to banish birds and wild animals by traditional hunting, which damages the ecological balance and wastes the human resources.

### SUMMARY OF THE INVENTION

This utility model provides an alarm device for banishment of birds and animals, which help to save the manpower, to protect the farm crops and to maintain the ecological balance, as described below:

An alarm device for banishment of birds and animals includes: radio transmission module, voltage stabilizing circuit and inverter circuit. The said radio transmission module sends radio signals to radio receiver module which then transmits such radio signals to the PC control circuit; the said PC control circuit sends instruction signals to the audio circuit which then transmits the audio signal to amplification circuit which outputs the amplified audio signals; the said voltage stabilizing circuit provides 5V power supply to the said radio transmission module, radio receiver module, the said PC control circuit and the said audio circuit, while the said inverter circuit provides +/−35V power supply to the said amplification circuit.

The said PC control circuit specifically includes: 2051A SCM.

The said audio circuit includes: human voice chip.

The 1#, 2# and 3# pins of the said human voice chip is connected to the instruction signals from the said PC control circuit and 4# and 6# pins are respectively connected to the said PC control circuit and the said amplification circuit.

The said human voice chip is a TH808 voice chip.

The said amplification circuit includes: the primary amplification chip and the secondary amplification chip. The 9# and 10# pins of the said primary amplification chip are respectively connected to the 9# and 10# pins of the said secondary amplification chip;

The 6# or 12# pin of the said primary amplification chip is connected, together with the 14# pin of the said primary amplification chip, to the primary output terminal via the primary capacitor; the 3# pin and the 2# pin of the said primary amplification chip are grounded respectively via the primary resistor and the secondary resistor; the 2# pin is also connected to the primary output terminal via the third resistor and connected to the secondary output terminal via the fourth resistor;

The 6# or 12# pin of the said secondary amplification chip is connected, together with the 14# pin of the said secondary amplification chip, to the secondary output terminal via the secondary capacitor; the 3# pin and the 2# pin of the said secondary amplification chip are grounded respectively via the fifth resistor and the sixth resistor; the 2# pin is also connected to the secondary output terminal via the seventh resistor;

In this device, the 9# pin and 10# pin of the said primary amplification chip and the said secondary amplification chip are connected, in parallel to voltage stabilizing diode and the eighth resistor and the 9# pin is grounded via the third capacitor; the 9# resistor is connected to +35V power and the 10# pin is grounded via the fourth capacitor.

The said primary amplification chip and the said secondary amplification chip are TDA7293/4 chips.

The said inverter circuit includes: alternating square-wave generator, of which the 8# pin is connected to DC 12V power, 2# pin is connected to the fifth capacitor and the tenth resistor, 10# pin outputs the primary alternating square wave and 9# pin outputs the secondary alternating square wave.

The said primary alternating square wave is connected to the base of primary triode, of which the collector is grounded and the emitter is connected respectively to the base of the secondary triode via the eleventh resistor, to the base of the third triode via the twelfth resistor, and to base of the fourth triode via the thirteenth resistor; the collectors of the said third triode and the fourth triode are grounded;

The said secondary alternating square wave is connected to the base of the fifth triode, of which the collector is grounded and the emitter is connected respectively to the base of the sixth triode via the fourteenth resistor, to the base of the seventh triode via the fifth resistor, and to base of the eighth triode via the sixth resistor; the collectors of the said seventh triode and the eighth triode are grounded;

The emitters of the said secondary triode, the said third triode, the said fourth triode, the said sixth triode, the said seventh triode and the said eighth triode are connected to the ring transformer to output positive and negative voltage; after rectified by the primary, secondary, the third and the fourth bilateral diodes and filtered by the sixth, seventh, eighth, ninth, tenth, eleventh, twelfth, thirteenth, fourteenth and the fifteenth capacitors, the ring transformer outputs DC +/−35V power.

The said alternating square-wave generator is: TL494.

This utility model provides an alarm device for banishment of birds and animals, which can realize the following benefits: with the PC control system, this device integrates DC power inverter, audio amplification, modularized audio source and remote control technologies, to banish birds and animals by means of intelligent simulation of human voices. In such a manner, it helps to reduce manpower and to effectively protect the farm crops, on another hand it can protect birds and wild animals from being killed or harmed in the traditional hunting, therefore, the device helps to maintain ecological balance.

### BRIEF DESCRIPTION OF THE DRAWINGS

FIG. 1 shows the structure diagram of an alarm device for banishment of birds and animals provided by this utility model;

FIG. 2 shows the schematic circuit diagram of the radio reception module provided by this utility model;

FIG. 3 shows the schematic diagram of the PC control circuit provided by this utility model;

FIG. 4 shows the schematic diagram of the audio source circuit provided by this utility model;

FIG. 5 shows the schematic diagram of the amplification circuit provided by this utility model;

FIG. 6 shows the schematic diagram of the inverter circuit provided by this utility model;

FIG. 7 shows the schematic diagram of the voltage stabilizing circuit provided by this utility model;

The numbers shown on such drawings represents the following parts:

| | |
|---|---|
| 1: Radio transmission module; | 2: Radio receiver module; |
| 3. PC control circuit; | 4. Audio circuit; |
| 5. Amplification circuit; | 6. Inverter circuit; |
| R50: The seventeenth resistor; | LED2: The primary LED; |
| S/IN1: the primary serial port; | U1: SCM; |
| A1A: Human voice chip; | IC1A: Primary amplification chip; |
| IC2A: Secondary amplification chip; | C28: Primary capacitor; |
| OUT1: Primary output terminal; | R25: primary resistor; |
| R26: Secondary resistor; | R27: the third resistor; |
| R28: the fourth resistor; | OUT2: Secondary output terminal; |
| C29: Secondary capacitor; | R29: the fifth resistor; |
| R31: the sixth resistor; | R30: the seventh resistor; |
| D6: Voltage stabilizing diode | R32: the eighth resistor; |
| C31: the third capacitor; | R33: the ninth resistor; |
| C30: the fourth capacitor; | C10: the fifth capacitor; |
| R10: the tenth resistor; | Q3: the primary triode; |
| R42: the eleventh resistor; | Q13: the secondary triode; |
| R15: the twelfth resistor; | Q5: the third triode; |
| Q6: the fourth triode; | R16: the thirteenth triode; |
| Q4: the fifth triode; | R43: the fourteenth resistor; |
| Q14: the sixth triode; | R18: the fifteenth resistor; |
| Q7: the seventh triode; | R19: the sixteenth resistor; |
| Q8: the eighth triode; | L2: the ring transformer; |
| Q10: the primary bilateral diode | Q12: the secondary bilateral diode; |
| Q9: the third bilateral diode; | Q11: the fourth bilateral diode; |
| C18: the sixth capacitor; | C19: the seventh capacitor; |
| C20: the eighth capacitor; | C21: the ninth capacitor; |
| C22: the tenth capacitor; | C23: the eleventh capacitor; |
| C24: the twelfth capacitor; | C25: the thirteenth capacitor; |
| C49: the fourteenth capacitor; | C50: the fourteenth capacitor; |
| CON2: the secondary serial port; | 7: Voltage stabilizing circuit. |

### DETAILED DESCRIPTION OF THE INVENTION

The embodiment of this utility model is further illustrated in details with help of drawings, in order to clarify the purpose, technical solution and advantages of this utility model.

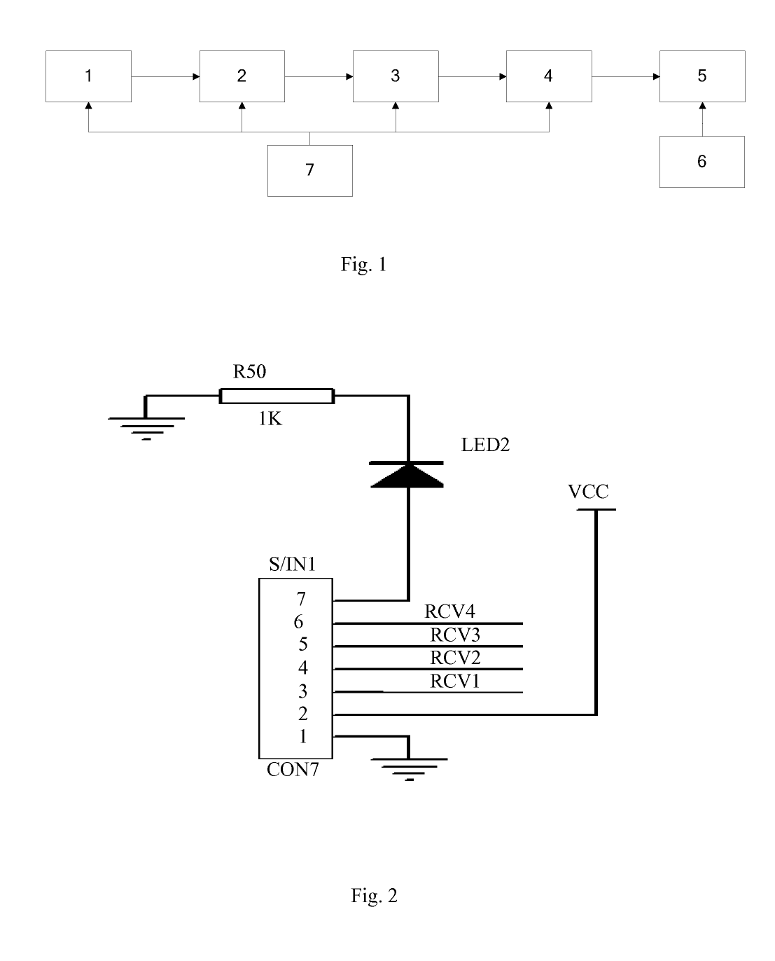

In order to save manpower and to protect farm crops and to maintain ecological balance, this utility model provides an alarm device for banishment of birds and animals, as shown in FIG. 1, which is described as follows:

1. An alarm device for banishment of birds and animals, as shown in FIG. 1, which includes: radio transmission module 1, inverter circuit 6 and voltage stabilizing circuit 7.

The radio transmission module 1 sends radio signals to radio receiver module 2 which then transmits such radio signals to the PC control circuit 3; the PC control circuit 3 sends instruction signals to the audio circuit 4 which then transmits the audio signal to amplification circuit 5 which outputs the amplified audio signals; the voltage stabilizing circuit 7 provides 5V power supply to the said radio transmission module 1, radio receiver module 2, the PC control circuit 3 and the audio circuit 4, while the inverter circuit 6 provides +/−35V power supply to the amplification circuit 5.

In this utility model, the radio transmission module adopts a general-purpose module available in the existing technology and this utility model makes no restriction in the embodiment example.

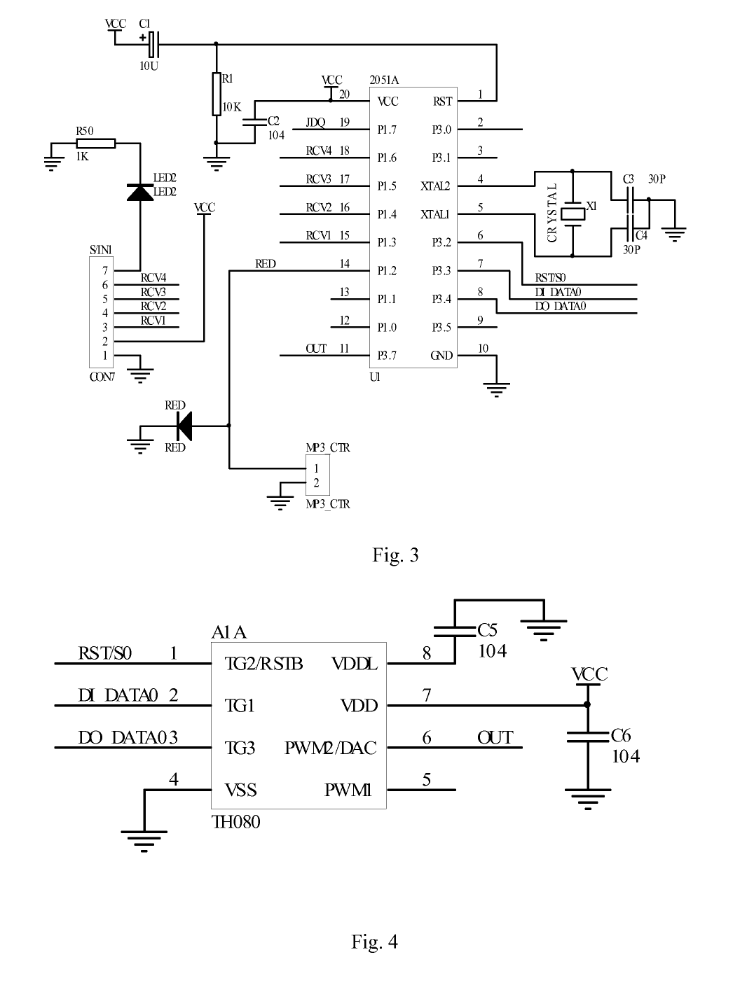

As shown in FIG. 2, the radio transmission module 2 includes: the seventeenth resistor R50, of which an end is grounded and the other is connected to the cathode of the primary LED2, the anode of the primary LED2 is connected to the 7# pin of primary serial port S/IN1, the 6#, 5#, 4# and 3# pins of primary serial port S/IN1 are respectively connected to the PC control circuit 3; the 2# pin is connected to +5V power while the 1# pin is grounded.

In this utility model, the radio reception module transmits radio signals received via the 6#, 5#, 4# and 3# pins to the PC control circuit 3, and such 6#, 5#, 4# and 3# pins represents four buttons on the remote controller. When a pin indicates high level, it means that the corresponding button to such pin is pressed down.

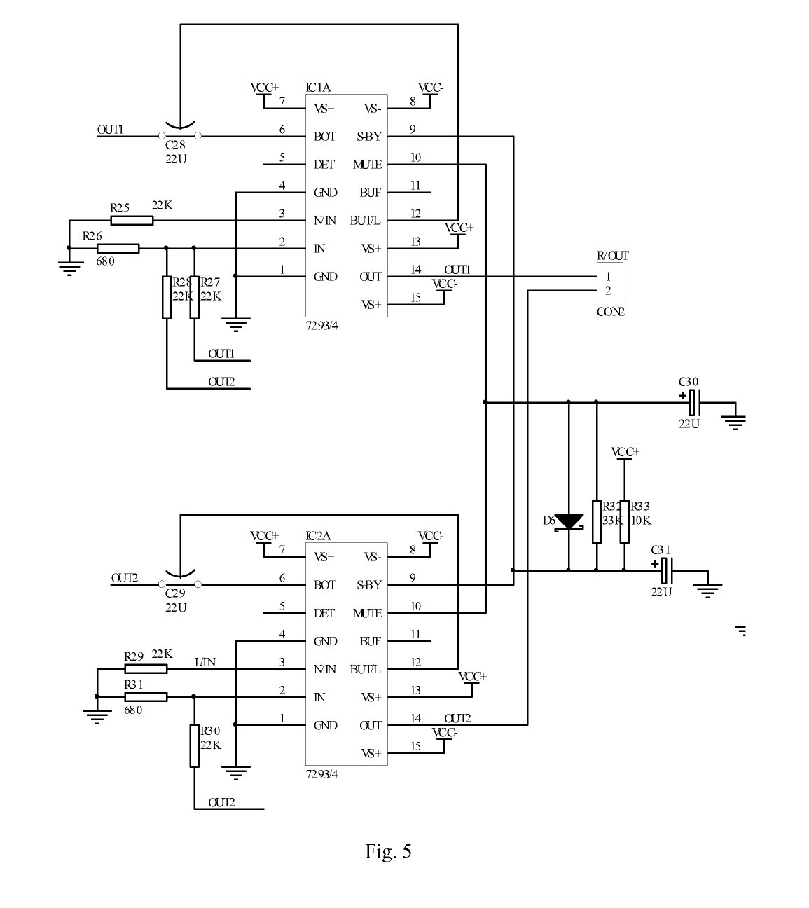

As shown in FIG. 3, the PC control circuit 3 includes: SCM U1, of which the P1.6, P1.5, P1.4 and P1.3 pins are used to receive the radio signals from the radio reception module 2, pin P1.7 is used to control power supply to amplification circuit 5, while pins P3.2, P3.3 and P3.4 are used to send instruction signals to audio source circuit 4.

In this utility model, when it is embodied, the PC control circuit 3 is 2051A SCM U1.

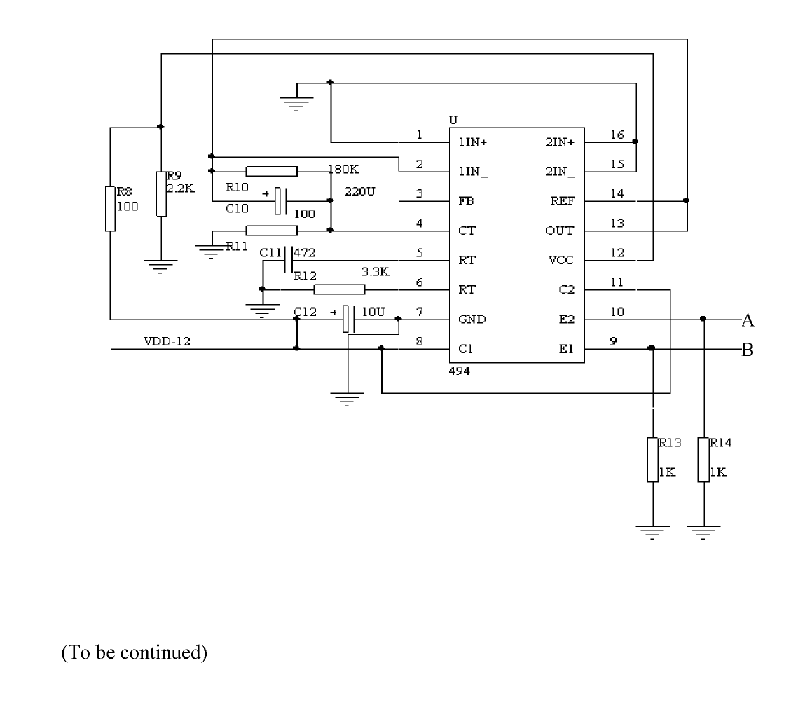

As shown in FIG. 4, the audio source circuit 4 includes: human voice chip A1A, of which the 1#, 2# and 3# pins are connected to the instruction signals from PC control circuit 3, the 4# pin is grounded and the 6# pin is connected respectively to PC control circuit 3 and amplification circuit 5.

In this utility model, when it is embodied, the human voice chip A1A is TH808 type voice chip.

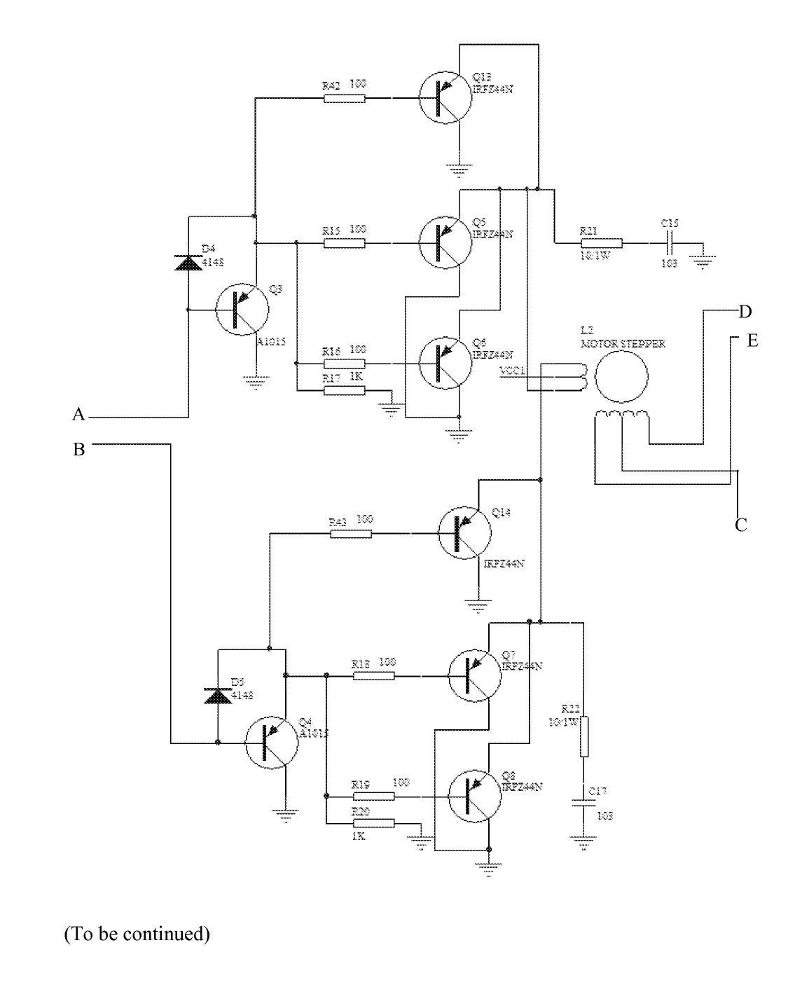

As shown in FIG. 5, the amplification circuit 5 includes: the primary amplification chip IC1A and the secondary amplification chip IC2A. The 9# and 10# pins of the primary amplification chip IC1A are respectively connected to the 9# and 10# pins of the secondary amplification chip IC2A;

The 6# or 12# pin of the primary amplification chip IC1A is connected, together with the 14# pin of the primary amplification chip IC1A, to the primary output terminal OUT1 via the primary capacitor C28; the 3# pin and the 2# pin of the said primary amplification chip IC1A are grounded respectively via the primary resistor R25 and the secondary resistor R26; the 2# pin is also connected to the primary output terminal OUT1 via the third resistor R27 and connected to the secondary output terminal OUT2 via the fourth resistor R28;

The 6# or 12# pin of the secondary amplification chip IC2A is connected, together with the 14# pin of the secondary amplification chip IC2A, to the secondary output terminal OUT2 via the secondary capacitor C29; the 3# pin and the 2# pin of the secondary amplification chip IC2A are grounded respectively via the fifth resistor R29 and the sixth resistor R31; the 2# pin is also connected to the secondary output terminal OUT2 via the seventh resistor R30;

In this device, the 9# pin and 10# pin of the primary amplification chip IC1A and the secondary amplification chip IC2A are connected, in parallel, to voltage stabilizing diode D6 and the eighth resistor R32 and the 9# pin is grounded via the third capacitor C31; the 9# resistor R33 is connected to +35V power and the 10# pin is grounded via the fourth capacitor C30.

In this utility model, when it is embodied, the primary amplification chip IC1A and the secondary amplification chip IC2A both adopt TDA7293/4 chips, by which the output power can be amplified to 150 W.

In this utility model, when the primary amplification chip IC1A adopts TDA7293 chip, the 12# pin of the primary amplification chip IC1A is connected, together with the 14# pin on the primary amplification chip IC1A, to the primary output terminal OUT1 via the primary capacitor C28; when the primary amplification chip adopts TDA7294 chip, the 6# pin of the primary amplification chip IC1A is connected, together with the 14# pin on the primary amplification chip IC1A, to the primary output terminal OUT1 via the primary capacitor C28.

In this utility model, when the secondary amplification chip IC2A adopts TDA7293chip, the 12# pin of the secondary amplification chip IC2A is connected, together with the 14# pin on the secondary amplification chip IC2A, to the secondary output terminal OUT2 via the secondary capacitor C29; when the secondary amplification chip adopts TDA7294 chip, the 6# pin of the secondary amplification chip IC2A is connected, together with the 14# pin on the secondary amplification chip IC2A, to the secondary output terminal OUT2 via the secondary capacitor C29.

In this utility model, the 3# pin of the secondary amplification chip IC2A is the input terminal of audio signals which are amplified by the primary amplification chip IC1A and the secondary amplification chip IC2A and are output to the extremal speaker via the secondary serial port CON2.

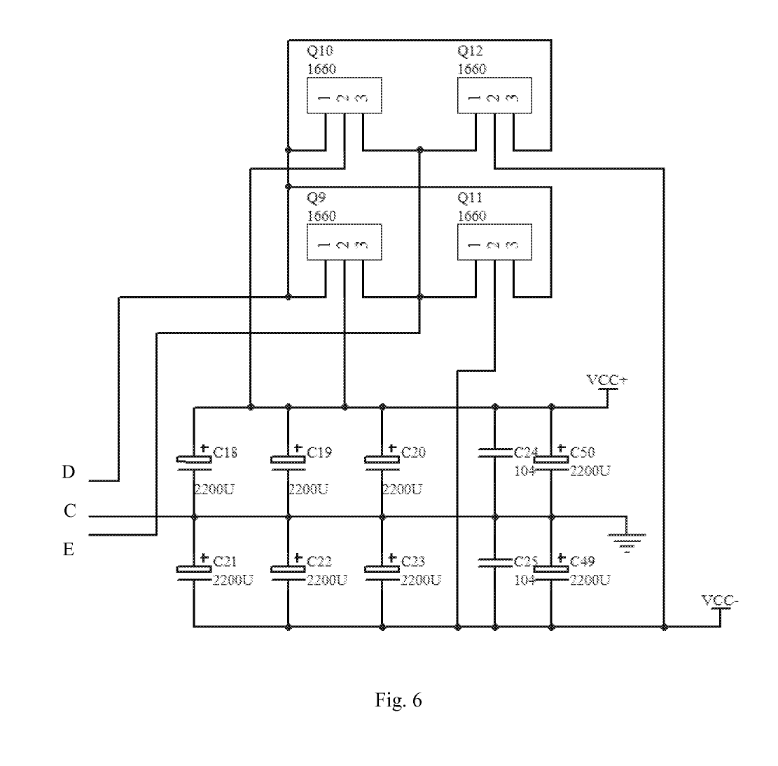

As shown in FIG. 6, the inverter circuit 6 includes: alternating square-wave generator, of which the 8# pin is connected to DC 12V power, the 2# pin is connected to the fifth capacitor C10 and the tenth resistor R10, the 10# pin outputs the primary alternating square wave and the 9# pin output the secondary alternating square wave. The primary alternating square wave is connected to the base of primary triode Q3 and the collector of primary triode Q3 is grounded; the emitter of primary triode Q3 is connected to the base of the secondary triode Q13 via the eleventh resistor R42 and to base of the third triode via the twelfth resistor R15, and to the base of the fourth triode Q6 via the thirteenth resistor R16; the collector of the third triode Q5 and the collector of the fourth triode Q6 are grounded;

The secondary alternating square wave is connected to the base of the fifth triode Q4, of which the collector is grounded and the emitter is connected respectively to the base of the sixth triode via the fourteenth resistor R43, to the base of the seventh triode Q7 via the fifth resistor R18, and to base of the eighth triode Q8 via the sixteenth resistor R19; the collectors of the seventh triode Q7 and the eighth triode Q8 are grounded;

The emitters of the secondary triode Q13, the third triode Q5, the fourth triode Q6, the sixth triode Q14, the seventh triode Q7 and the eighth triode Q8 are connected to the ring transformer L2 to output positive and negative voltage; after rectified by the primary Q10, secondary Q12, the third Q9 and the fourth Q11 bilateral diodes and filtered by the sixth C18, seventh C19, eighth C20, ninth C21, tenth C22, eleventh C23, twelfth C24, thirteenth C25, fourteenth C49 and the fifteenth C50 capacitors, the ring transformer outputs DC +/−35V power.

In this utility model, when it is embodied, the alternating square-wave generator is TL494.

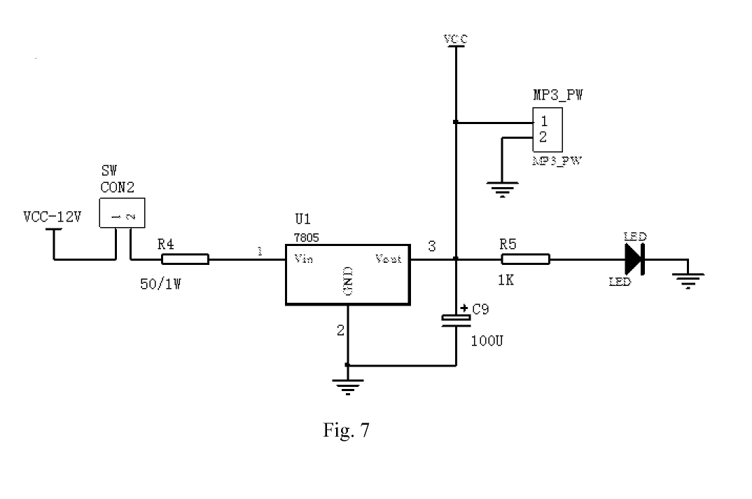

As shown in FIG. 7, the voltage stabilizing circuit 7 is connected to DC 12V power, which, after stabilized, outputs DC 5V power to supply power to the radio transmission module 1, radio receiver module 2, PC control circuit 3 and audio circuit 4.

In this system, the embodiment example of this utility model does not have any restrictions on the models of above-mentioned components and in the real embodiment, the utility model will not have any restrictions either.

In all, this utility model embodiment example provides an alarm device for banishment of birds and animals, which, with the PC control system, integrates DC power inverter, audio amplification, modularized audio source and remote control technologies, to banish birds and animals by means of intelligent simulation of human voices. In such a manner, it helps to reduce manpower and to effectively protect the farm crops, on another hand it can protect birds and wild animals from being killed or harmed in the traditional hunting, therefore, the device helps to maintain ecological balance.

Technical persons in this area can understand that the drawing attached works only as a preferred embodiment example and the numbers in the above utility model embodiment example are only for description purpose and do not stand for the advantages or disadvantages of the embodiment example.

The description above is only a relatively favorable embodiment example of this utility model and constitutes no limitation on such utility model. All modifications, equivalent substitution and improvements under the guideline and principles of this utility model are covered in the protection range of this utility model.

1. An alarm device for banishment of birds and animals, which is characterized by that such device includes: radio transmission module, voltage stabilizing circuit and inverter circuit.
The said radio transmission module sends radio signals to radio receiver module which then transmits such radio signals to the PC control circuit; the said PC control circuit sends instruction signals to the audio circuit which then transmits the audio signal to amplification circuit which outputs the amplified audio signals; the said voltage stabilizing circuit provides 5V power supply to the said radio transmission module, radio receiver module, the said PC control circuit and the said audio circuit, while the said inverter circuit provides +/−35V power supply to the said amplification circuit.

2. According to claim 1 above, an alarm device for banishment of birds and animals, which is characterized by that the said PC control circuit specifically includes: 2051A SCM.

3. According to claim 1 above, an alarm device for banishment of birds and animals, which is characterized by that the said audio circuit includes: human voice chip.
The 1#, 2# and 3# pins of the said human voice chip is connected to the instruction signals from the said PC control circuit and 4# and 6# pins are respectively connected to the said PC control circuit and the said amplification circuit.

4. According to claim 1 above, an alarm device for banishment of birds and animals, which is characterized by that the said human voice chip includes: TH808 human voice chip.

5. According to claim 1, an alarm device for banishment of birds and animals, which is characterized by that the said amplification circuit includes: the primary amplification chip and the secondary amplification chip. The 9# and 10# pins of the said primary amplification chip are respectively connected to the 9# and 10# pins of the said secondary amplification chip;
The 6# or 12# pin of the said primary amplification chip is connected, together with the 14# pin of the said primary amplification chip, to the primary output terminal via the primary capacitor; the 3# pin and the 2# pin of the said primary amplification chip are grounded respectively via the primary resistor and the secondary resistor; the 2# pin is also connected to the primary output terminal via the third resistor and connected to the secondary output terminal via the fourth resistor;
The 6# or 12# pin of the said secondary amplification chip is connected, together with the 14# pin of the said secondary amplification chip, to the secondary output terminal via the secondary capacitor; the 3# pin and the 2# pin of the said secondary amplification chip are grounded respectively via the fifth resistor and the sixth resistor; the 2# pin is also connected to the secondary output terminal via the seventh resistor;
In this device, the 9# pin and 10# pin of the said primary amplification chip and the said secondary amplification chip are connected, in parallel to voltage stabilizing diode and the eighth resistor and the 9# pin is grounded via the third capacitor; the 9# resistor is connected to +35V power and the 10# pin is grounded via the fourth capacitor.

6. According to claim 1 above, an alarm device for banishment of birds and animals, which is characterized by that the said primary and secondary amplification chips are TDA7293/4 chips.

7. According to claim 1 above, an alarm device for banishment of birds and animals, which is characterized by that the said inverter circuit includes: alternating square-wave generator, of which the 8# pin is connected to DC 12V power, 2# pin is connected to the fifth capacitor and the tenth resistor, 10# pin outputs the primary alternating square wave and 9# pin outputs the secondary alternating square wave.
The said primary alternating square wave is connected to the base of primary triode, of which the collector is grounded and the emitter is connected respectively to the base of the secondary triode via the eleventh resistor, to the base of the third triode via the twelfth resistor, and to base of the fourth triode via the thirteenth resistor; the collectors of the said third triode and the fourth triode are grounded;
The said secondary alternating square wave is connected to the base of the fifth triode, of which the collector is grounded and the emitter is connected respectively to the base of the sixth triode via the fourteenth resistor, to the base of the seventh triode via the fifth resistor, and to base of the eighth triode via the sixth resistor; the collectors of the said seventh triode and the eighth triode are grounded;
The emitters of the said secondary triode, the said third triode, the said fourth triode, the said sixth triode, the said seventh triode and the said eighth triode are connected to the ring transformer to output positive and negative voltage; after rectified by the primary, secondary, the third and the fourth bilateral diodes and filtered by the sixth, seventh, eighth, ninth, tenth, eleventh, twelfth, thirteenth, fourteenth and the fifteenth capacitors, the ring transformer outputs DC +/−35V power.

8. According to claim 7 above, an alarm device for banishment of birds and animals, which is characterized by that the said alternating square-wave generator is: TL494.
